(19) United States
(12) Patent Application Publication
(10) Pub. No.: US 2024/0367125 A1
(43) Pub. Date: Nov. 7, 2024

(54) Device for determining the temperature of a mixture in a rotary mixer

(71) Applicant: Hauschild GmbH & Co. KG, Hamm (DE)

(72) Inventors: Theodor EITZEN, Hamm (DE); Patrick ADAM, Drensteinfurt (DE)

(73) Assignee: Hauschild GmbH & Co. KG, Hamm (DE)

(21) Appl. No.: 18/687,014

(22) PCT Filed: Aug. 31, 2021
(86) PCT No.: PCT/DE2021/000144

§ 371 Date: Feb. 28, 2024

(51) Int. Cl. B01F 35/21; G01J 5/00

(52) U.S. Cl. CPC B01F 35/2115; G01J 5/0037

(57) ABSTRACT

A device for determining the temperature of a mixed material in a rotary mixer includes a stationary housing and a mixing container that can be moved on a circular path into different rotational positions about a main axis of rotation. A mixed material receptacle in form of a solid of revolution has a bottom and a side wall, and an axis of symmetry arranged obliquely to the plane of the circular path and orthogonally to the bottom. The mixing container is rotatably mounted about the axis of symmetry and the device in an idle state has no material to be mixed and in an operating state in which the mixing container is filled with material to be mixed, rotates on the circular path, with a non-contact measuring radiation detector being arranged in a stationary manner on the housing, which is directed towards the circular path.

### CROSS-REFERENCE TO RELATED APPLICATION

This application is a national stage application, filed under 35 U.S.C. § 371, of International Patent Application PCT/DE2021/000144, filed on Aug. 31, 2021.

### TECHNICAL FIELD

The present disclosure relates to a device for determining the temperature of a mixed material in a rotary mixer.

### BACKGROUND

Determining the temperature of a mixed material allows statements to be made about the condition of the mixed material and thus also about whether the desired mixing has already been achieved or whether further mixing needs to take place. The continuous recording of the mixed material temperature in the mixing process is also suitable as an in-process control and can quickly identify unwanted deviations during mixing, as well as segregation processes caused by mixing for too long.

The prior art literature mainly contains measurement techniques that require direct contact of a measuring sensor with the mixed material. DE 1 257 113 A discloses a mixer for fine-grained, powdery or liquid/mushy material with an upright cylindrical, lockable mixing container and high-speed rotating mixing tools arranged concentrically therein. Among other things, it sets itself the task of determining the continuously increasing actual temperature of the mixed material during the mixing process in a particularly simple and suitable manner. It is proposed to design a deflector for the mixed material in cross section as a body that tapers in the direction of rotation of the mixing tools with supply lines for liquids and/or gases and a thermometer. In a practical embodiment, a thermometer sensor is arranged in the deflector, which protrudes from the deflector near the lower end of the deflector on the side facing the container wall. The sensor extends diagonally downwards and at an acute angle to the container wall. The sensor protrudes forward from the deflector in such a direction that the mixed material, which is rotated and pushed upwards, hits the tip of the sensor practically vertically. This prevents the mixed material from settling on dead zones of the sensor and thereby forming a heat-insulating layer on the sensor surface, which makes it impossible for the thermometer to display a largely instantaneous and accurate display. The measuring line of the remote thermometer is routed through the cavity of the deflector.

DE 10 113 451 A1 discloses a bearing housing for a stirring shaft, to which a stirring disk is preferably attached, with a lance, which is connected to the bearing housing at one end and at the other end of which a temperature sensor is arranged, with a supply line for the temperature sensor, which is guided at least in some areas through the bearing housing and which extends at least in some areas through the lance to the temperature sensor. The lance is preferably provided with a predetermined breaking point. Here, too, there is the problem that part of the temperature measuring device, in this case the lance, is arranged in the mixing vessel and is therefore exposed to the risk of excessive mechanical forces.

DE 10 2008 041 104 A1 initially discloses a mixing device which consists at least partially of an electrically conductive, preferably metallic, material. By means of a heating device which has at least one coil that can be excited with an alternating electric field and which is arranged in such a way that eddy currents are generated in the electrically conductive material of the mixing container by the change in the magnetic field that occurs when the current flow changes, the mixing container and the mixed material contained in it can be heated quickly, as the eddy currents cause the mixing container to heat up. In a preferred embodiment, at least one scraper device is provided inside the container near the container wall and/or the container bottom, which is movable relative to the container wall. In the simplest case, the scraper device is static, so that the necessary relative movement is only generated by rotating the container. According to DE 10 2008 041 104 A1, the temperature of the mixed material can now be detected by a temperature sensor which is accommodated in the scraper device, since this is in direct contact with the mixed material. Alternatively, the temperature of the mixed material can also be determined by a product-contacting or non-contact temperature sensor inserted into the mixing space separately from the scraper device. Here too, the temperature sensor is always in the mixing container.

### SUMMARY

A disadvantage of the prior art is the fact that all temperature sensors have previously been positioned in the mixing container. At high speeds, as can occur in rotary mixers, the corresponding temperature sensors are therefore exposed to high centrifugal forces and the electronic connection or cabling can require a lot of maintenance or the sensors have to frequently be replaced. In addition, measurement inaccuracies can arise if it is not possible to generate a material flow along the sensor, as mixed material caked on the sensor can have a heat-insulating effect. A non-contact measuring sensor, in which the sensor is nevertheless positioned in the mixing container, would definitely have to be positioned in such a way that contamination with mixed material can be excluded, which would require a lot of design effort and would also require individual adjustments depending on the mixer.

The present disclosure provides a device which eliminates the mentioned disadvantages of the prior art and is particularly suitable for rotary mixers which have a high mechanical load on all components.

Presented is a device for determining the temperature of mixed material in a rotary mixer with a housing and with a mixing container that can be moved on a circular path into different rotational positions. The device has a mixed material receptacle with a bottom and a side wall that is formed as a solid of revolution. The mixed material receptacle is arranged with an axis of symmetry at an angle to the plane of the circular path and orthogonally to the bottom. The mixing container is rotatably mounted about the axis of symmetry. The device has no mixed material in an idle state and rotates on the circular path in an operating state in which the mixing container is filled with mixed material. A non-contact measuring radiation detector is arranged in a stationary manner on the housing. The radiation detector is directed towards the circular path. The radiation detector is preferably part of a pyrometer that detects infrared radiation. In principle, other detectors can also be used, which allow conclusions to be drawn about the temperature of the mixed material based on the reflection of electromagnetic radiation and so work without contact.

The core of the radiation detector is preferably a radiation sensor, onto which incident radiation is preferably focused by a suitable lens. The extent of the maximum area detected by the radiation detector as a measuring spot on a measurement object, here the mixed material, depends proportionally on the distance between the radiation detector and the measurement object. The greater the distance between the radiation detector and therefore also the radiation sensor from the mixed material, the larger the area of the measuring spot.

The radiation detector cannot be arbitrarily oriented. In order to record the mixed material temperature with sufficient accuracy, it is directed at least towards the circular path on which the mixing container moves in the operating state. However, it is advantageous if the measuring spot in the idle state lies in at least one rotational position completely in the half of the surface of the bottom that is furthest away from the plane of the circular path within the mixed material receptacle and in the operating state at least part of the mixed material is in one or more rotational positions completely introduced into the beam path of the radiation detector. It should be taken into account that, for example, in the idle state, the mixed material distributed over the entire surface of the bottom of the mixed material receptacle is displaced in the course of rotation, i.e. in the operating state of the device, by centrifugal forces in the direction of the respective upper edge of the mixed material receptacle, thereby causing parts of the bottom and the upwardly adjacent container wall to be covered. Normally, the mixed material receptacle in the mixing container performs a counter-rotation to the movement of the mixing container on the circular path in order to prevent the mixed material from sticking to the container wall. The mixed material receptacle can also usually be easily replaced.

It is particularly preferred if the distance of the radiation detector from the bottom of the mixed material receptacle is selected so that the circular measuring spot on the bottom of the mixed material receptacle has a diameter that is no larger than the radius of the bottom. The measuring spot can thus be positioned completely in the upper half of the bottom.

Since a preferably aligned radiation detector without high-precision timing not only detects the temperature of the mixed material but also the environment of the mixing container, which does not have any mixed material, it is advantageous if the radiation detector is connected to a data processing unit. The data processing unit is advantageously configured to record the data units received from the radiation detector, to calculate individual temperature values from the data units and to determine the respective maximum of the individual temperature values in predetermined time periods. It is particularly advantageous if local maxima of a series of temperature values can also be output, so that a distinction can be made between the mixed material and possibly other temperature peaks, which could be caused, for example, by malfunctions of the rotary mixer. An emergency shutdown or warning device can also be linked to reaching a certain threshold value.

Finally, it is advantageous and usually essential that the data processing unit is set up to calculate the individual temperature values by specifying the emissivity of the mixed material. Since in many applications there are only small differences in the material to be mixed, renewed presetting of the emissivity is only necessary if the mixed material is fundamentally changed.

In mixing processes for which negative pressure compared to normal pressure is required, the radiation detector can be fixed in place on or in the housing in such a way that it is arranged together with the temperature detector in a space that can be sealed in such a way that a uniform negative pressure compared to normal pressure can be generated therein, to which the mixed material and the radiation detector are equally exposed. This has the advantage that there is no need to position a lid between the mixed material and the radiation detector, which would influence the measurement even with transparent panes. For mixing processes that absolutely require a cover, in practice usually a lid closing the mixing container, a germanium disk can be installed in the lid, which is positioned in at least one rotational position of the mixing container in the beam path of the radiation detector. Germanium disks can be designed in such a way that they have no influence on the measurement.

A method that uses the proposed device for determining temperature comprises the following steps:
i) filling the mixing container with the mixed material and positioning the mixed material in the beam path of the radiation detector with subsequent determination of the temperature of the mixed material at rest as T0 using the data processing unit;
ii) transferring the device into the operating state with a speed of rotation of the mixing container on the circular path of more than a predetermined number of revolutions per minute (rpm);
iii) selectively measuring the mixed material temperature at regular time intervals;
iv) determining the maximum measured mixed material temperature after a predetermined number of revolutions.

In this way, it can also be recorded how quickly the temperature rises in mixed materials with a high proportion of friction and the rotation speed, or cooling, can be adjusted accordingly to optimize the mixing process. For this purpose, it is advantageous to always determine temperature maxima after a certain number of revolutions of the mixing container on the circular path, record them as a graph, and evaluate them.

It is of significance that the temperature determination takes place at specific points using the radiation detector, so that there is a measurement-free period of time between the individual determinations. During the measurement-free period, i.e. the time interval between the individual measurements, the mixed material container continues to rotate and covers a certain distance depending on the speed, which is usually specified in revolutions per minute (rpm). In order to achieve good accuracy of the measurements, it is therefore advantageous if the distance covered during the time interval is not greater than the radius of the bottom of the mixed material receptacle in order to ensure a high probability that a measurement takes place in the operating state of the device in which the measuring spot only detects mixed material. The value of the time interval between the point measurements, specified in milliseconds, should therefore preferably not be greater than the quotient of the radius of the bottom of the mixed material receptacle and one 60,000th of the speed (rpm) multiplied by the circumference of the circular path.

The presented device is explained below using the drawing as an example without being limited to this example.

### BRIEF DESCRIPTION OF THE DRAWINGS

FIG. 1 shows a section of a rotary mixer (2) in cross section.

### DETAILED DESCRIPTION

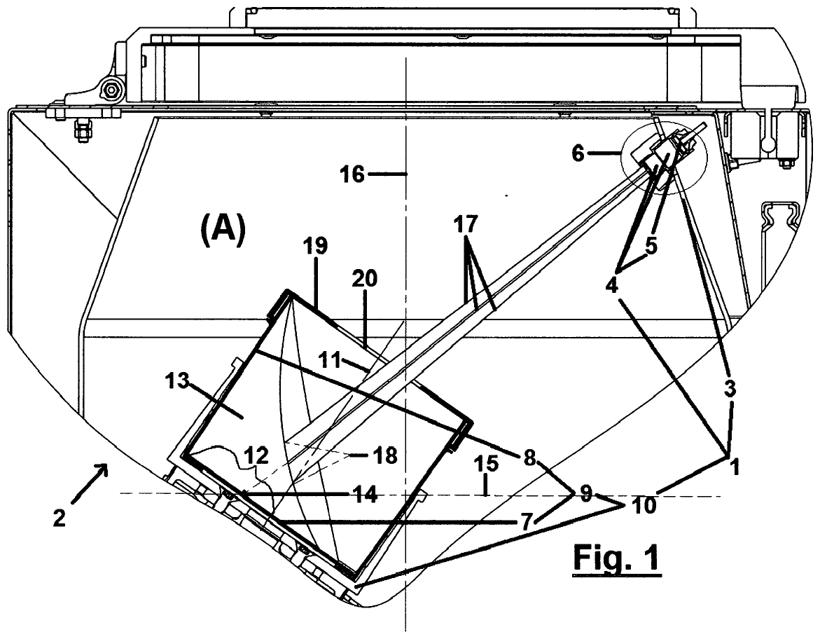

FIG. 1 shows a section of a rotary mixer (2) in cross section, which has a device for temperature determination (1), consisting of a stationary housing (3) and a radiation detector (4) with a radiation sensor (5) as part of a pyrometer (6) and a mixing container (10) which has a bottom (7), a side wall (8) and an easily replaceable mixed material receptacle (9). The mixing container (10) can be moved into various rotational positions about a main axis of rotation (16) on a circular path (14), which passes through the intersection of the center of the beam path (17) with the bottom (7) and is shown here as a point, wherein the mixing container (10) is designed as a solid of revolution, the axis of symmetry (11) of which is arranged orthogonally to the bottom (7) and obliquely to the plane (15) of the circular path (14). The radiation detector (4) is arranged on the stationary housing (3) in such a way that the beam path (17) of the pyrometer (6) is directed towards the circular path (14). Shown here is the device (1) in its operating state (A), in which the mixing container (10) rotates on the circular path (14) and the mixed material receptacle (9) is filled with mixed material (13), which is here shifted in the direction of the upper half of the mixed material receptacle (9) due to the rotation of the mixing container (10) about the main axis of rotation (16). In the rotational position of the mixing container (10) shown, the measuring spot (18) is located completely on the mixed material (13) and in the idle state (R) (not shown here), i.e. in the absence of the mixed material (13), would be located on the upper half of the bottom (7) of the mixed material receptacle (9). This is possible because the diameter of the circular measuring spot (18) is smaller than the radius of the bottom (7). The optional lid (19) is also shown here, which closes the mixed material receptacle (9) and thus effectively prevents, for example, fine powdery substances from escaping. The beam path (17) is aligned so that in at least one rotational position of the mixing container (10) it runs completely through the germanium disk (20) installed in the lid (19).

### REFERENCE NUMERALS

1 device for determining temperature
2 rotary mixer
3 housing
4 radiation detector
5 radiation sensor
6 pyrometer
7 bottom
8 side wall
9 mixed material receptacle
10 mixing container
11 axis of symmetry
12 radius of the bottom
13 mixed material
14 circular path
15 plane of the circular path
16 main axis of rotation
17 beam path
18 measuring spot
19 lid
20 germanium disc

1.-14. (canceled)

15. A device (1) for determining a temperature of a mixed material (13) in a rotary mixer (2), comprising:
a stationary housing (3);
a mixing container (10) that can be moved on a circular path (14) into different rotational positions about a main axis of rotation (16), the mixing container (10) having
a mixed material receptacle (9) with
a bottom (7) and
a side wall (8),
wherein the mixed material receptacle (9) is in form of a solid of revolution with an axis of symmetry (11) arranged obliquely to a plane (15) of the circular path (14) and orthogonally to the bottom (7); and
a non-contact measuring radiation detector (4) arranged in a stationary manner on the housing (3),
wherein the mixing container (10) is rotatably mounted about the axis of symmetry (11),
wherein the device (1) in an idle state (R) has no mixed material (13) and in an operating state (A) the mixing container (10) filled with mixed material (13) rotates on the circular path (14), and
wherein radiation detector (4) is directed towards the circular path (14).

16. The device (1) according to claim 15,
wherein the radiation detector (4) has a radiation sensor (5) on which incident radiation is focused, and
wherein the extent of the maximum area detected by the radiation detector (4) as a measuring spot (18) on the mixed material (13) is proportionally dependent on the distance between the radiation detector (4) and the mixed material (13).

17. The device (1) according to claim 16,
wherein the measuring spot (18) in the idle state (R) is completely in an upper half of a surface of the bottom (7) within the mixed material receptacle (9), and
wherein in the operating state (A) at least a part of the mixed material (13) is completely introduced into a beam path (17) of the radiation detector (4) in one or more rotational positions.

18. The device (1) according to claim 17
wherein the measuring spot (18) is circular and has a diameter that is not larger than a radius of the bottom (7) of the mixed material receptacle (9).

19. The device (1) according to claim 17,
wherein the radiation detector (4) is connected to a data processing unit.

20. The device (1) according to claim 15,
wherein the radiation detector (4) is part of a pyrometer (6).

21. The device (1) according to claim 19,
wherein the data processing unit is configured
to record data units received by the radiation detector (4),
to calculate individual temperature values from the data units, and
to determine a respective maximum of the individual temperature values in predetermined time periods.

22. The device (1) according to claim 21,
wherein the data processing unit is configured to calculate the individual temperature values by specifying an emissivity of the mixed material (13).

23. The device (1) according to claim 17,
wherein the mixing container (10) has a closable lid (19),
wherein a germanium disk (20) is installed in the closable lid (19),
wherein the germanium disk (20) is positioned in at least one rotational position of the mixing container (10) in the beam path (17) of the radiation detector (4) and is so designed that it has no influence on a measurement using the radiation detector (4).

24. The device (1) according to claim 15,
wherein the mixed material (13) and the radiation detector (4) are arranged in a space which can be sealed in such a way that a uniform negative pressure compared to normal pressure can be generated therein, to which the mixed material (13) and the radiation detector (4) are equally exposed.

25. A method, comprising:
providing the device (1) according to claim 19;
filling the mixing container (10) with the mixed material (13) and positioning the mixed material (13) in the beam path (17) of the radiation detector (4);
subsequently determining the temperature of the mixed material (13) at rest as T₀ using the data processing unit;
transferring the device (1) into the operating state (A) with a speed of rotation of the mixing container (10) on the circular path (14) of more than a predetermined number of revolutions per minute (rpm);
selectively measuring the temperature of the mixed material at regular time intervals; and
determining the maximum measured mixed material temperature after a predetermined number of revolutions.

26. The method according to claim 25, further comprising:
repeatedly determining the maximum measured mixed material temperature after the predetermined number of revolutions.

27. The method according to claim 26, further comprising:
recording of the temperature maxima as a graph.

28. The method according to claim 25,
wherein a value of the time intervals between the measurements specified in milliseconds is not greater than a quotient of a radius of the bottom (12) of the mixed material receptacle (9) and a 60,000th of the speed (rpm) multiplied by a circumference of the circular path (14).
